(19) United States
(12) Patent Application Publication
(10) Pub. No.: US 2011/0279657 A1
(43) Pub. Date: Nov. 17, 2011

(54) ADAPTER PLATE FOR DISPLAY DEVICE AND METHOD FOR MAKING OF STEREO VISUAL VISUALIZATION IN DETERMINED VISUAL DISTANCE

(76) Inventors: Karoly Pados, Budapest (HU); Karoly Pados, JR., Budapest (HU)

(21) Appl. No.: 12/998,480

(22) PCT Filed: Oct. 26, 2009
(86) PCT No.: PCT/HU2009/000087

§ 371 Date: Jul. 27, 2011

(30) Foreign Application Priority Data
Oct. 27, 2008 (HU) P0800636

(51) Int. Cl. H04N 13/04

(52) U.S. Cl. 348/51; 348/E13.075

(57) ABSTRACT

Adapter plate applicable for use with display devices for making of stereo visual visualization in given visual distance (R) wherein the pixel size (8) of the display device is determined. The adapter plate comprises parallel non-transparent covering stripes (9) formed on a transparent plate and arranged in a plane. The adapter plate is placed before a flat screen of the display device. The widths of the parallel covering stripes (9) and the spacing between them are determined proportionally to the visual distance (R)1 the pixel size (8) and the particular position of the adapter plate.

### FIELD OF THE INVENTION

The invention relates to an adapter plate which can be manufactured economically. By applying the adapter plate in a predetermined (advantageously variable) position onto a common electronic display device (TFT or LCD monitor, plasma television, other devices provided with pixels arranged in a square-grid, advertising signs etc.) provided with vertically disposed pixel columns the depth information of stereo still and motion pictures—without the use of a special viewing device—can be perceived by the naked eye or by means of polarized glasses, thereby a real, three-dimensional image with true colours is obtained by the viewer.

The invention also relates to a method for making of stereo visual visualization in a given visual distance, in the method pixel points produced in parallel stripes are presented on the flat screen of the display device for the right and left eye simultaneously, and an adapter plate is placed in a predetermined position on the flat screen of the display device.

### BACKGROUND OF THE INVENTION

The principle of display has been known for at least a century. The basic idea is that the stereo image pair is cut into vertical stripes and every second stripe from the right and left image is placed next to each other by turns. Then by means of a viewing device or effecting some methods the image stripes originating from the left image are transmitted to the left eye, the image stripes from the right image are transmitted to the right eye, and the brain fuses them into perception of a three-dimensional virtual image.

In this field number of patents are known, but each of them have some substantial disadvantages, therefore non of them is employed widely.

The known proposals can be divided into two groups: some of them are applicable without the use of a viewing device, others need some kind of glasses. In addition to improving the quality efforts has been made to eliminate the use of the viewing device.

In one of the solutions for viewing stereo paper photographs produced by the above mentioned method the images are folded along the border lines of the stripes or perpendicular dividing stripes are employed, and when the images are viewed from a certain point correct recombination is resulted due to the parallax of the two eyes (FIG. 1).

As it can be seen in the Figure, this method is cumbersome and deficient.

Another solution is proposed especially for projections wherein the above mentioned left-right stripes are produced by means of a grid made of bars of the same width. The grid is placed between the back of a translucent screen and the two projectors, and by viewing the images from the front through a similar grid stepreo effect is elicited (FIG. 2).

The disadvantages of this solution are that it requires a large space (projection and viewing takes place on opposite sides), a special (translucent) screen, rather heavy grids, keeping the appropriate distance is not easy, the whole apparatus is cumbersome and expensive. The resolution is also roughly limited.

This is true for its finer version with grids and images produced by conventional photographic methods in which the right and left image stripes are projected onto an image and by viewing it through another grid three-dimensional effect is elicited. A further disadvantage of this solution is that the light intensity is reduced because of the grid therefore the degree of colour saturation, brilliance are also reduced. In addition to the aforementioned problems relating to quality these procedures are time-consuming and require great accuracy therefore they have not been used widely, they are considered merely as attempts and as a matter of curiosity.

According to another proposal a so called lenticular foil comprising an array of cylinder lens is used and the images of the right-left stripes appropriately positioned under these lens result in a virtual image providing a stereo effect in eye distance (FIG. 3).

Execution of this requires great accuracy since the foil must be positioned precisely, the foil comprising the cylinder lens is expensive and resolution is limited by the width of the cylinder lens.

Solutions employing glasses or some sort of viewing device have been more successful since separation of the right and left image for the eye is much simpler. However, their fundamental disadvantage is that some device must be worn before the eyes on the head. Their common idea is that a sort of distinctive filter e.g. removing red and blue (so called anaglyph method), or a horizontal and vertical polar filter, or a light blocking liquid crystal device transmitting one of the images then the other by turns in a synchronized manner is placed in front of the right and left image (FIG. 4). A further technical problem in this case concerning the monitors is that the image content is exchanged by doubled frequency.

A simple solution is to view the mechanically or optically separated images or small-sized screens through an ocular lens or prism (FIG. 5).

As the principle of these devices is different from the principle of the invention they have been mentioned shortly, only for the sake of completeness.

Returning to the solutions employing a parallax grid, the deficiencies—arising from the inaccuracy due to the rough stripe resolution—were negligible relative to the dimensions of the stripes. In these solutions the widths of the stripes and the width of the spacing between them were equivalent to the left-right picture elements. In order to eliminate the deficiencies the covering black stripes were uniformly slightly wider than the width of the spacing further deteriorating the contrast/brightness conditions.

As the currently used electronic display devices are capable for providing a significantly higher resolution due to the micron accuracy pixel size and positioning, the aforementioned deficiencies are not negligible any more, and use of the grids produced according to the known methods is limited because of the quality requirements as they produce acceptable stereo effect only in a small part of the image area.

### The Aim of the Invention

A device and method for providing real three-dimensional images eliminating the above mentioned deficiencies and capable for producing a perfect image throughout the entire screen is proposed, which can be manufactured economically so that it can be employed widely.

In order to enhance its economical character the device according to the invention can be used with conventional apparatuses so that there is no need for replacing the already existing display devices.

This is achieved by providing a supplementary device for use with conventional apparatuses. The aim is to make the use of the same device with a number of different apparatuses possible. In order to obtain the best stereo effect the device can be adjusted to a given viewing zone.

Finally, for convenient use of the device as far as possible there is no need for the viewer to wear a viewing device.

The above mentioned technical-economical advantages can be realized by a more appropriately sized (taking more parameters into account) parallax grid whose position is adjustable and which can be applied as an adapter plate on a display device. Therefore the aim of the invention is to provide a parallax adapter plate of this kind.

### DISCLOSURE OF THE INVENTION

The aim of the invention is achieved by an adapter plate applicable for use with display devices for making of stereo visual visualization in given visual distance wherein the pixel size of the display device is determined, the adapter plate comprises parallel non-transparent covering stripes formed on a transparent plate and arranged in a plane, the adapter plate is placed before a flat screen of the display device. The widths of the parallel covering stripes and the spacing between them are determined proportionally to the visual distance, the pixel size and the particular position of the adapter plate. (In this context pixel means any kind of picture element.)

In an advantageous embodiment of the adapter plate applicable for use with display devices according to the invention at least either the widths of the parallel covering stripes or the spacing between them within the given grid are varied proportionally to the effective visual distance (R+x), the adapter plate is placed before the flat screen of the display device in a predetermined distance, the predetermined distance is ensured by the thickness of the material of the transparent plate, and in the transparent stripes being between the non-transparent stripes, further parallel covering stripes which are indifferent with respect to the stereo effect are placed in order to improve the colour balance.

In another advantageous embodiment of the adapter plate applicable for use with display devices according to the invention the adapter plate is provided with mechanical or electromechanical adjusting means for its accurate positioning relative to the screen, adjusting means for horizontal positioning of the adapter plate relative to the screen and/or adjusting the angle between the screen and the vertical axes of the adapter plate and/or adjusting the distance between the screen and the adapter plate. It is also possible to control it by means of a remote control. Further, in certain embodiments the adapter plate is provided with adjusting means controlled by a receiver-controller adapted to detect the displacement of a signalling device worn on the head of a viewer and transmitting radio, light, infrared light or ultrasound signals. Opposite the viewer a video camera is placed the signal of which controls the adjusting means through an evaluation unit. The adapter plate and one or more fixing means for fixing the adapter plate are provided with magnets with their like poles facing each other. The non-transparent covering stripes comprise LCD elements which can be switched off.

In a further advantageous embodiment of the invention the adapter plate applicable for use with display devices for making of stereo visual visualization the pixel size of the display device is determined, the adapter plate comprises cells formed and disposed in a plane on a transparent plate, the size of the cells corresponds to the size of the pixels and they are arranged alternately for transmission of orthogonally polarized light beams.

The display device according to the invention is an LCD, TFT, plasma or OLED based display device, wherein the pixel size of the device is determined, the device comprises cells in front of the transparent carrier layer containing the pixels, the size of the cells corresponds in relation to the size of the pixels and the cells are arranged alternately for transmission of orthogonally polarized light beams.

The method according to the invention is adapted for making of stereo visual visualization in a given visual distance, in the method pixels produced in parallel stripes for the right and left eye simultaneously are displayed on the flat screen of the display device, and an adapter plate according to the invention is placed in a predetermined position on the flat screen of the display device.

The aim according to the invention is achieved by a method in which pixels produced alternately for the right eye and the left eye are displayed on the screen of a display device and for viewing eye-glasses are used containing a pair of orthogonal polarizing filters.

### BRIEF DESCRIPTION OF THE DRAWINGS

FIG. 1 schematically shows a method for producing 3D images according to a prior art solution.

FIG. 2 schematically shows a prior art method for 3D projection.

FIG. 3 schematically shows the lenticular method.

FIG. 4 shows the application of light blocking LC (Liquid Crystal) device ac cording to the prior art.

FIG. 5 schematically shows the conception of 3D perception.

FIG. 6 explains the change in the visual distance.

FIG. 7 explains how the covering stripes are shifted and changed in size as required for carrying out the invention.

FIG. 8 schematically shows how the colour balance is improved.

FIG. 9 shows a possible embodiment in which the adapter plate is fixed by means of magnets.

FIG. 10 shows the positioning of the adapter plate relative to the screen ac cording to the invention.

FIG. 11 shows an arrangement for automatic positioning according to one embodiment of the invention.

FIG. 12 shows an embodiment of the adapter plate according to the invention in which LC cells are employed.

FIG. 13 shows an embodiment of the adapter plate according to the invention in which cells with alternating polarity are employed.

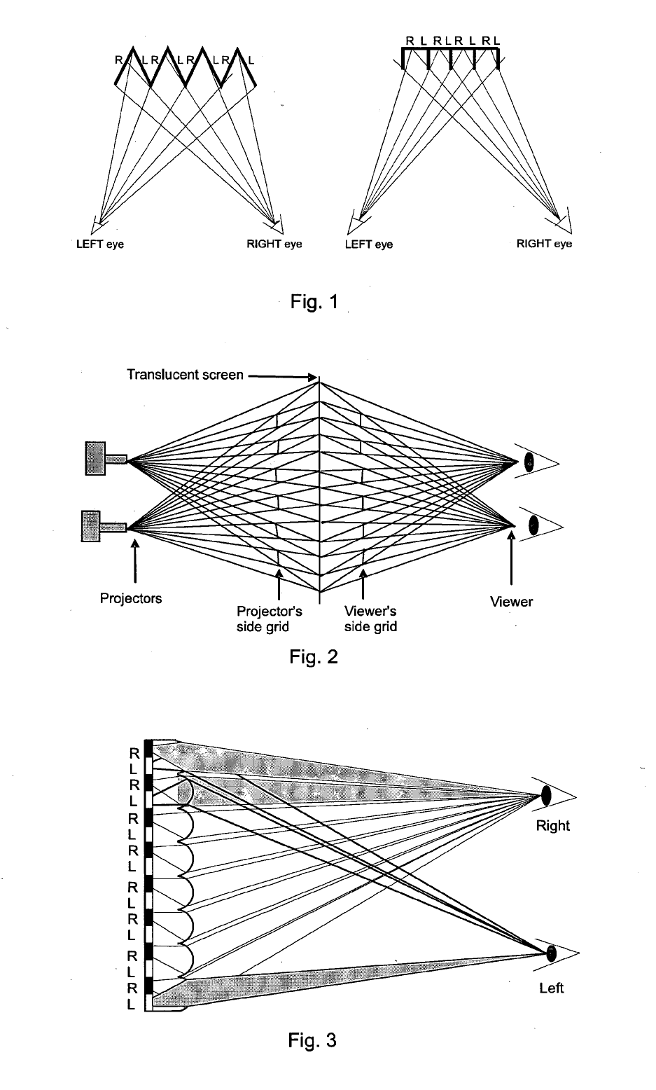

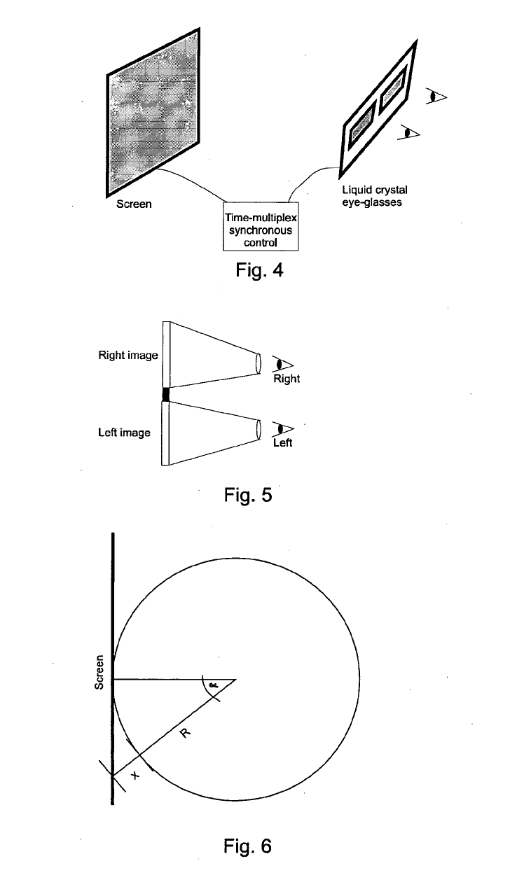

### DETAILED DESCRIPTION OF THE INVENTION

The invention is an adapter plate applicable to devices related in the first paragraph comprising a grid provided with non-transparent stripes applied on a transparent material, wherein the distance between the covering stripes 9 as well as the width of the grid lines change as a function of the parameters (pixel size, distance of the grid, refraction, visual distance, parallax, etc.) of a particular application.

Since the visual distance measured from the screen is constant along an arc of a circle in which the eye stands for the centre point while the screen is flat, the visual distance per stripes changes according to the following relation (see FIG. 6):

$$R + x = \frac{R}{cos α}$$

where

R=visual distance in the centre of the screen.

R+x=visual distance further off the centre of the screen.

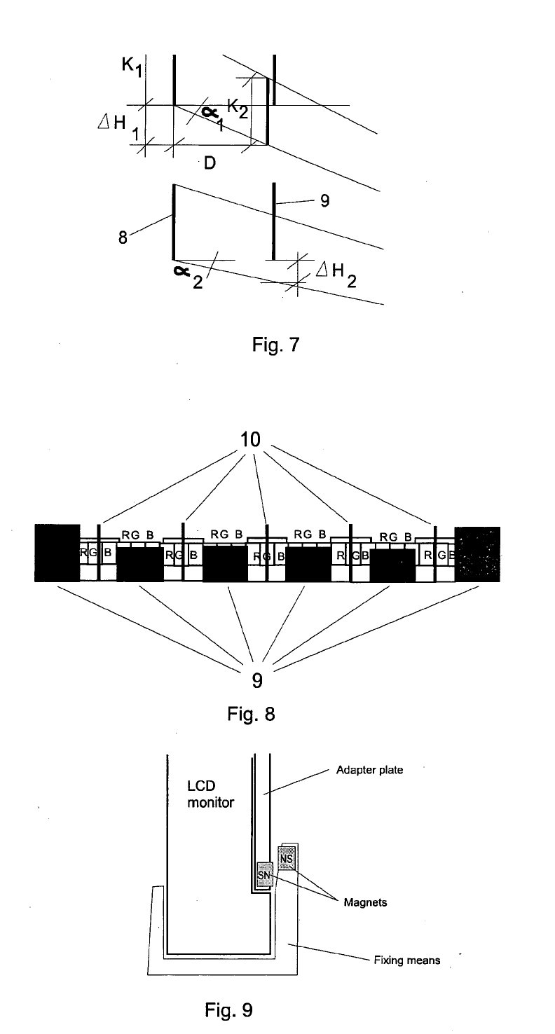

As the angle of view is changing towards the edge of the image comprised of pixels 8 the stripe position and the stripe width must be calculated using beam tracing per line (FIG. 7).

$$\begin{matrix}{K}_{1} > {K}_{2} {e}^{′} s Δ {H}_{1} > Δ {H}_{2} \\ Δ {H}_{1} = D \cdot t g {α}_{1} \\ Δ {H}_{2} = D \cdot t g {α}_{2} \\ ⋮ \\ Δ {H}_{N} = D \cdot t g {α}_{N}\end{matrix}$$

The effect of refraction can be calculated by applying the well known Snell-Descartes law:

$$n = \frac{sin α}{sin β}$$

where α=incident angle, (β=angle of refraction, n=refraction index

The relations used for calculation—as the above examples show—are relatively simple and they do not form a part of the invention. The innovative step lies in producing the grid through a method in which all of the parameters and their interrelations are taken into consideration in a complex system, and by defining the exact travel of beams the position and the boundary of the covering stripes 9 are determined individually (see FIG. 7).

These parameters were not taken into consideration in case of known grids, therefore they did not provide perfect stereo images from any optional places. In patent application GB 2 405 542 a parallax grid is disclosed in which the line distance is the integral multiple of the pixel size or slightly less, and the parallax grid itself is placed directly on the surface of the display device. Here, the aim is to place the grid the nearest possible to the pixels, incorporated in the display, thereby increasing the angle of separation between the right-left images. In case of an optimized grid produced according to the method of the invention where the size and the position of all grid lines are exactly defined individually, the widths of the parallel covering stripes 9 and the distance between them—even when viewed from a fixed viewing position—will vary proportionally to the effectual visual distance R+x in accordance with the method of invention. According to the present invention by realizing the parallax grid as an adapter plate, it can be positioned further from the pixels by orders of magnitude in an adjustable manner, thereby ensuring that positioning of the grid can be determined by the viewer according to the visual distance required by him. In this manner from a given position and from its close neighbourhood a perfect stereo effect can be obtained simultaneously throughout the whole screen.

The great amount of calculation needed for making the grid comprised of covering stripes 9 is performed by a computer program. As this program does not constitute a part of the invention it is not dealt with in details, only the essence of the method of the invention necessary for producing the grid has been disclosed. Some of the parameters and the manner they are used in the method have been shown as examples.

A typical manufacturing process to produce the adapter plate may be as follows:

Parameters of the given application is fed as input data in a suitable computer program.

By means of the program the specific width and position of the individual stripes are calculated on the basis of the input data (parameters) and the master positive of the optimized grid is obtained as output.

The master positive is applied on the carrier by means of some known method (e.g. photolithography). Then the adapter plate is equipped with some mechanical means adapted for fixing and adjusting it.

For the user the method of image processing may comprise the following steps:

A suitable test diagram is displayed on the screen of a display device e.g. computer.

The adapter plate is placed and fixed on the monitor.

The adapter plate is adjusted in accordance with the required viewing position by means of the test diagram.

An image processing program is started.

It is assumed that a left-right stereo image pair produced in a conventional manner is available on the computer in some common extension (bmp, jpg, etc.).

From the input left-right image pair the image processing program produces the stereo image comprised of alternating left-right pixels. Then it is displayed through the adapter plate providing a real three-dimensional experience for the viewer when viewing it from a proper distance.

The best images can be obtained when the viewer sits in the middle, opposite the screen. To the right and left from the calculated area first ghosting occurs then the stereo effect turns over, the front and the back are inverted because the eyes will perceive the image which was intended to the other eye. Moving towards to the left or right, the image content is restored and again the correct stereo effect is obtained. Therefore a good image can be obtained from the middle and from radial zones of given angles to the right and left. The viewing zones can not be made continuous in a simple manner due to the principle of operation, the geometry of the system. By applying the adapter plate good stereo effect can be obtained from the sides, too, but the width of the individual viewing zones may be further improved.

In this manner one can relatively easily find an optimal viewing position from where a correct stereo effect can be obtained and ghosting does not occur even if the viewer moves a little.

An obvious solution would be to slightly increase the width of the covering stripes in order to block the eyes from seeing under the covering stripe 9 thereby it can be avoided that the image produced for the other eye is seen even if the viewer moves a bit.

This solution is not applicable directly because in current colour monitors the individual pixels comprise red r, green g and blue b colour components, so called “sub-pixels” sequentially, so if some of the sub-pixels on the two sides are covered, colour distortion occurs because of the change in colour proportion.

According to an embodiment of the invention in the adapter plate shown in FIG. 8 a covering stripe 10 indifferent with respect to the stereo effect is placed in the vicinity of the centre line of the transparent stripes. The width of the covering stripes 10 is proportional to the width of the non-transparent covering stripes 9 in order to improve the colour balance.

A special problem to be solved is that the fixing means and the adapter plate is pressed against the screen as an integral unit while displacement of the adapter plate perpendicular to the screen must be made possible.

To solve this problem a special fixing method is proposed. As it is shown in FIG. 9 magnets with their like poles facing each other are mounted both on the adapter plate and the fixing means. These magnets repel each other thereby ensuring the perpendicular pressure force against the screen. At the same time they make unhampered lateral displacement possible.

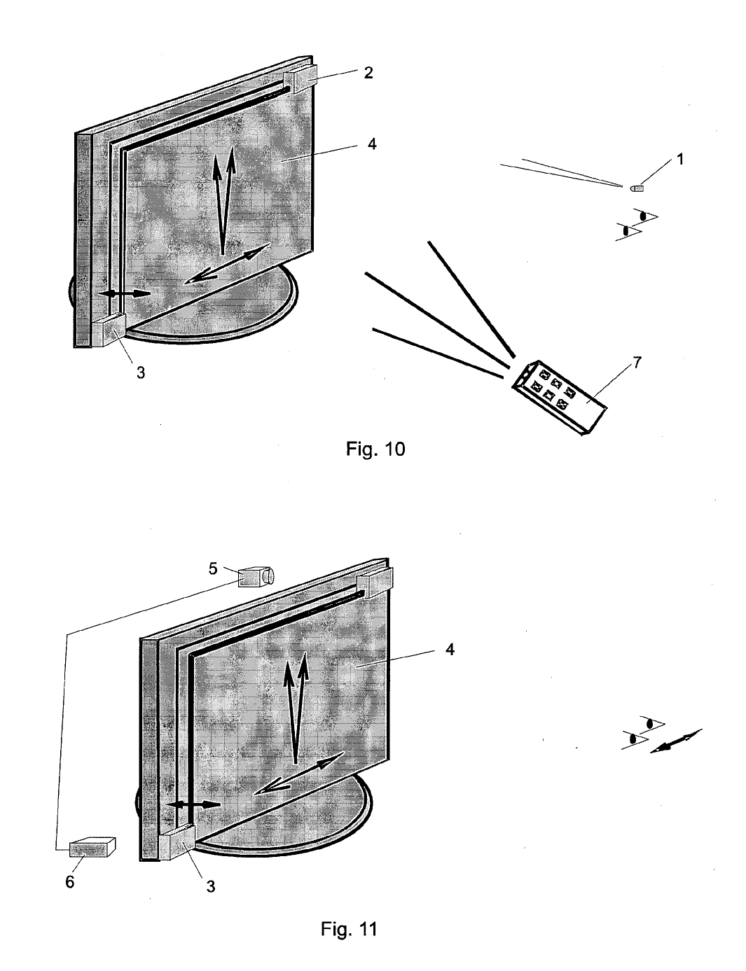

In FIG. 10 another advantageous embodiment of the invention can be seen in which mechanical or electromechanical adjusting means 3 are provided mounted on the adapter plate or the display device by means of which precise positioning relative to the screen becomes possible. In this manner the user can optimally adjust the adapter plate to his viewing zone.

It can be done manually, in which case the exact positioning of the adapter plate is adjusted by using some mechanical means e.g. screws, eccentric means, lifting mechanism or other means well known in the field of precision mechanics. In case of longer viewing distance adjustment can be done by means of either a wired or a wireless remote control 7, while the effective adjustment is performed by a small-sized electric adjusting means 3 connected mechanically to the adapter plate.

Still another advantageous embodiment of the invention can be an arrangement in which a small-sized, light signaller 1 transmitting radio, light (infra), ultrasound etc. signals. A receiver-controller 2 practically placed in the vicinity of the screen detects the displacement of the signaller 1 and accordingly the position of grid 4 is modified electronically.

In this manner the area in which good stereo effect can be obtained for the viewer is increased thereby the viewer may move in a certain extent.

Naturally, the different functional units may be integrated physically.

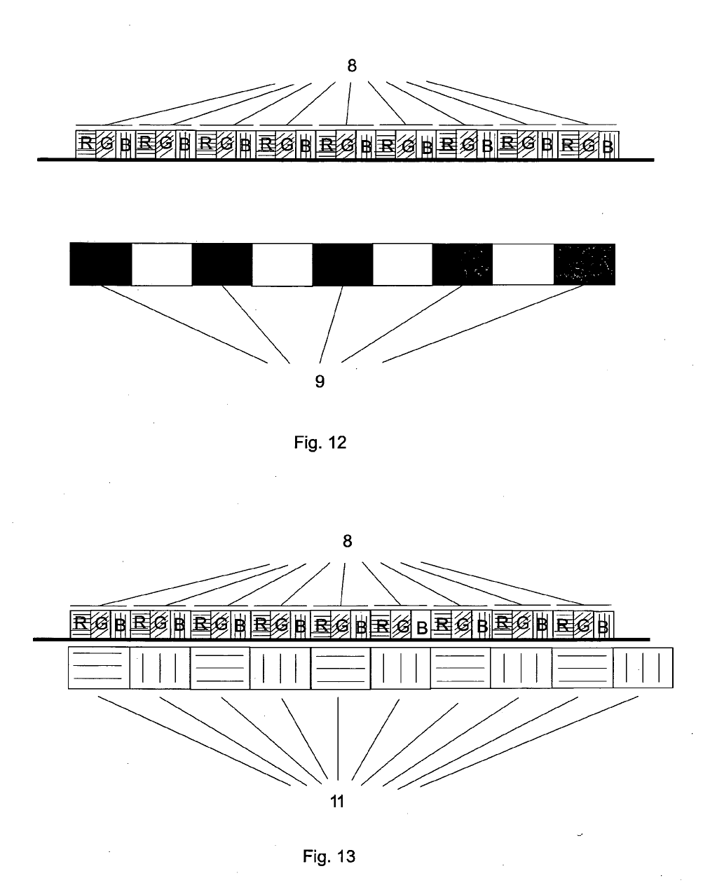

Still in an advantageous embodiment of the invention a video camera 5 is placed opposite the viewer. The signal of the camera is transmitted into an evaluation unit 6 in which the displacement of the viewer is detected on the basis of a change in the video signal, and in accordance with this change the position of the grid can be adjusted automatically as it was explained in the previous paragraph. This is shown in FIG. 11. The advantage of this solution is that the viewer does not have to wear a signalling device.

The different embodiments may be combined with each other.

The only inconvenience remaining is that the adapter plate must be placed on for stereo applications and removed for non-stereo applications.

This is solved by a grid operating on the same principle, in which the covering stripes can be switched on and off, that is, they are transparent when the grid is used for 2D applications and they are non-transparent for stereo applications.

This alternative embodiment of the invention is shown in FIG. 12, wherein the covering stripes are in the form of liquid crystal cells. The position and size of these cells can be calculated in a manner described previously.

The liquid crystal cell of the grid before the respective pixel can be electrically activated according to known LCD technology so that it becomes non-transparent and a stereo grid is provided.

When the cells are in inactive state the grid is transparent for common 2D applications.

In this case the adapter plate may be built in the screen during the manufacturing process of the display device to ensure the precise adjustment of it and to make its switching on/off possible. In this manner a compact factory-made stepreo TV or monitor is provided. However, in this case the adapter plate can not be used with an already existing display device.

In an alternative embodiment of the invention eye-glasses containing a pair of orthogonal polarizing filters may be used for viewing the images. With this solution the range of the viewing zones is extended, i.e. neither the angles of view nor the viewing distance is limited, three-dimensional image can be obtained from a wide angle. In this way more people can watch TV in stereo or in case of other application many people can view the display from optional positions.

Real three-dimensional home-movie can be attained.

Efforts have been made for a while to utilize the anaglyph method. To this colour eye-glasses had to be worn, and the transmitter transmitted the different colour components of the left and right images, therefore the colours and the three-dimensional effect were not perfect.

For separation it is more correct to make use of the polarizable character of light since the human eye is not sensitive to this. Cinemas offering high quality three-dimensional effect (e.g. Disneyland or Imax system) operate in this manner. In this case differently polarized images must be transmitted which must not be changed by the screen. Cathode-ray tubes of the conventional TV sets are not suitable for it because of the refraction and diffraction conditions resulting from their rather great wall thickness. However, LCD monitors or TV sets may be made suitable for it by utilizing the present invention.

A further advantage of this solution is that 2D-3D compatibility can be provided.

This alternative embodiment of the invention is shown in FIG. 13. In the adapter plate shown in the Figure cells 11 sized correspondingly to the size of the pixels and transmitting e.g. vertically and horizontally but essentially orthogonally polarized light are positioned alternately. This adapter plate may be connected to the screen or incorporated into it.

For physical realization of this LCD technology may be used.

The method then comprises the following steps: the source transmits the 2D programme in a conventional manner and it is processed and displayed in a usual way either with a 2D or a 3D receiver. The sequentially alternating horizontally and vertically polarized pixels can be seen without the use of polarized eye-glasses because the eye is insensible to polarization.

In case of a 3D programme one of the images (e.g. the left) is transmitted in the same way while the other (or rather the difference information of the two images) is transmitted encoded.

The 3D receiver produces a stereo image from the two images (from one of the images and from the difference information) by means of a decoder where the left and right pixels follow each other alternately behind the horizontally-vertically polarizing cells.

In case of digital transmission it can be realized a relatively simple manner, by employing an object hardware using a suitable software. The object hardware can be disconnected by switching it off. In case of 2D transmissions the image is displayed on the screen without change and in case of 3D transmission it is displayed through the decoder (stereo mode of operation) or, if one does not want to watch the 3D programmes in stereo then only the left or only the right image is displayed directly on the screen.

In stereo mode of operation when polarized eye-glasses correspondent to the adapter plate are used the respective image is seen by the eyes, therefore the three-dimensional image can be enjoyed even if the viewer moves away from the viewing position in a greater extent.

1. An adapter plate for use with a display device having a predetermined pixel size and a flat screen for stereo visual visualization at a given visual distance from the flat screen, said adapter plate comprising parallel, spaced non-transparent covering stripes on a transparent plate and defining transparent stripes therebetween, said non-transparent covering stripes being arranged in a plane, said adapter plate being adapted for positioning before the flat screen of the display device, the widths of said parallel covering stripes and the spacing between them being proportioned to said visual distance and said pixel size.

2. The adapter plate according to claim 1 characterized in that at least one of said widths of said parallel covering stripes or said spacing between them is proportional to an effective visual distance which is equal to the visual distance from the flat screen of the display device divided by the cosine of the angle of view from an eye of a viewer to a given position on the flat screen.

3. The adapter plate according to claim 1 characterized in that said adapter plate is mounted before the flat screen of the display device at a predetermined distance.

4. The adapter plate according to claim 3 characterized in that said predetermined distance is the thickness of the material of said transparent plate.

5. The adapter plate according to claim 1 characterized in that in said transparent stripes between said non-transparent covering stripes, further parallel covering stripes indifferent with respect to the stereo effect are placed in order to improve the colour balance.

6. The adapter plate according to claim 1 characterized in that said adapter plate is provided with mechanical or electromechanical adjusting means for its accurate positioning relative to the screen.

7. The adapter plate according to claim 6 characterized in that said adapter plate is provided with adjusting means for adjusting its horizontal positioning relative to the screen and/or the angle between the screen and the vertical axes of said adapter plate and/or said distance between the screen and said adapter plate.

8. The adapter plate according to claim 1 characterized in that said adapter plate is provided with adjusting means controllable by a remote control.

9. The adapter plate according to claim 6 characterized in that said adapter plate is provided with adjusting means controlled by a receiver-controller unit adapted to detect the displacement of a signaling device worn on the head of a viewer and transmitting radio, light, infrared light or ultrasound signals.

10. The adapter plate according to claim 6 characterized in that a video camera is placed opposite the viewer, a signal of the video camera controlling said adjusting means through an evaluation unit.

11. The adapter plate according to claim 6 characterized in that said adapter plate and one or more fixing means for fixing said adapter plate are provided with magnets with their like poles facing each other.

12. The adapter plate according to claim 1 characterized in that said non-transparent covering stripes are formed from LCD elements which can be switched off.

13. An adapter plate for use with a display device for stereo visual visualization, characterized in that said adapter plate comprises cells formed and disposed in a plane on a transparent plate, and the size of said cells corresponds to the size of pixels in the display device, and the cells are arranged alternately for transmission of orthogonally polarized light beams.

14. A display device characterized in that said device comprises cells before a transparent carrier layer containing pixels, and the size of said cells corresponds to the size of the pixels in the display device and said cells are arranged alternately for transmission of orthogonally polarized light beams.

15. A method for stereo visual visualization at a given visual distance from a flat screen of a display device which comprises displaying simultaneously, pixels produced in parallel stripes for the right and left eye of a viewer on the flat screen of the display device and placing an adapter plate in accordance with claim 1 on the flat screen of the display device.

16. The method according to claim 15 in which pixels produced in parallel stripes alternately for the right and left eye are displayed simultaneously on the flat screen of the display device including an adapter plate; and viewing the pixels through eye-glasses containing a pair of orthogonal polarizing filters; wherein the adapter plate comprises cells formed and disposed in a plane on a transparent plate, the size of said cells corresponding to the size of pixels on the flat screen of the display device, the pixels being arranged alternately for transmission of orthogonally polarized light beams.

17. A method for stereo visual visualization in which pixels produced alternately for the right and left eye are displayed on a display device according to claim 14 characterized in that eye-glasses corresponding to the display device and containing a pair of orthogonal polarizing filters are used for viewing the display.
